(19) United States
(12) Patent Application Publication
(10) Pub. No.: US 2021/0119345 A1
(43) Pub. Date: Apr. 22, 2021

(54) ANTENNA UNIT, ANTENNA MODULE, AND ELECTRONIC DEVICE

(71) Applicant: AAC Technologies Pte. Ltd., Singapore city (SG)

(72) Inventors: Yewchoon Tan, Singapore (SG); Guanhong Ng, Singapore (SG)

(21) Appl. No.: 16/997,969

(22) Filed: Aug. 20, 2020

(30) Foreign Application Priority Data
Oct. 18, 2019 (CN) 201910996154.3

(51) Int. Cl. H01Q 21/06; H01Q 1/48; H01Q 1/36

(52) U.S. Cl. CPC H01Q 21/061; H01Q 1/36; H01Q 1/48

(57) ABSTRACT

An antenna unit, an antenna module, and an electronic device are disclosed. The antenna unit includes: a first circuit board, a system ground and a feeding structure being formed on the first circuit board; a first metal frame, stacked on the first circuit board; and a first radiating element, stacked on the first circuit board. The first metal frame is arranged around an outer periphery of the first radiating element, the first radiating element includes a pair of first radiating arms opposite to and spaced apart from each other, and the pair of first radiating arms are attached to two opposite inner surfaces of the first metal frame. Both the first radiating element and the first metal frame are electrically connected to the system ground.

### TECHNICAL FIELD

The described embodiments relates to the field of communication, and more specifically, to an antenna unit, an antenna module, and an electronic device.

### BACKGROUND

With the advent of 5G era, higher data transmission rates are required. Millimeter waves have unique characteristics of high carrier frequency and large bandwidth, these unique characteristics are main technical means to realize 5 G ultra-high data transmission rate. Therefore, rich bandwidth resources of millimeter wave frequency band provide guarantee for high-speed transmission rate. 26 GHz (24.25-27.5 GHz) and 28 GHz (27.5-29.5 GHz) in the 5 G frequency band may meet the requirements for high traffic and high density of users. In particular, the 26 GHz frequency band has a continuous spectrum exceeding 3 GHz.

However, due to severe space loss of electromagnetic waves in the millimeter wave frequency band, a wireless communication antenna system using the millimeter wave frequency band need to adopt a phased-array structure to increase a gain and a bandwidth of the antenna module. In addition, in the millimeter wave frequency band, if line-of-sight communication cannot be maintained between a transmitter and a receiver of the antenna system, the communication link is easily interrupted. Therefore, an ability of the millimeter-wave antenna to control a radiation beam is very important for maintaining the line-of-sight communication.

Therefore, it is necessary to provide an antenna module and an electronic device to achieve higher gain and larger bandwidth.

### SUMMARY

In some aspects of the present disclosure, an antenna unit may be disclosed. The antenna unit may include: a first circuit board, wherein a system ground and a feeding structure are formed on the first circuit board; a first metal frame, stacked on the first circuit board; and a first radiating element, stacked on the first circuit board, wherein the first metal frame is arranged around an outer periphery of the first radiating element, the first radiating element comprises a pair of first radiating arms opposite to and spaced apart from each other, and the pair of first radiating arms are attached to two opposite inner surfaces of the first metal frame. Both the first radiating element and the first metal frame are electrically connected to the system ground.

In some embodiments, a horn-shaped opening is defined between the pair of first radiating arms of the first radiating element.

In some embodiments, the first circuit board comprises a first grounding layer, a first grounding spacer, a second grounding layer, a second grounding spacer, and a third grounding layers subsequently stacked on one another. The first grounding layer defines a first slot; each of the first grounding spacer, the second grounding layer, the second grounding spacer, and the third grounding layer defines a first clearance region facing the first slot; each of the first grounding spacer, the second grounding layer, and the second grounding spacer defines a second clearance region perpendicularly intersected and communicated with the corresponding first clearance region defined in the first grounding spacer, the second grounding layer, and the second grounding spacer; the first circuit board further comprises: a feeding line, received in the second clearance region defined in the second grounding layer; and a feeding post, running through the first circuit board, electrically connected to the feeding line, and electrically isolated from the first grounding layer, the second grounding layer, and the third grounding layer. The first metal frame and the first radiating element are arranged above the first grounding layer, the pair of first radiating arms of the first radiating element are symmetrically arranged at two opposite sides in a width direction of the first slot. One of the first radiating arms is arranged to cover the feeding post, the first radiating arm defines a relief groove at one end facing the feeding post, and the relief groove is configured to provide a clearance for the feeding post.

In some embodiments, the first circuit board further comprises a third grounding spacer and a fourth grounding layer. The third grounding spacer is disposed at one side of the third grounding layer away from the second grounding spacer, and the fourth grounding layer is disposed at one side of the third grounding spacer away from the third grounding layer. The third grounding spacer defines a third clearance region, and orthographic projections of the first clearance region and the second clearance region projected on the third grounding spacer are all disposed within the third clearance region. The third grounding layer, the third grounding spacer, the third clearance region, and the fourth grounding layer cooperatively define a rear chamber of the antenna unit.

In some embodiments, the feeding post passes through the third clearance region and is electrically isolated from the fourth grounding layer.

In some embodiments, the third clearance region comprises a dielectric having a dielectric constant different from that of the third grounding spacer.

In some embodiments, the first circuit board defines a through hole running through the first, second, and third grounding spacers. The feeding post passes through the through hole and is further electrically connected to one end of the feeding line.

In some embodiments, the first grounding spacer has a thickness substantially equal to that of the second grounding spacer, and the third grounding spacer has a thickness 2.5 times the thickness of the first grounding spacer.

In some embodiments, each of the pair of first radiating arms comprises: a first side wall, a second side wall, disposed at one end of the first side wall adjacent to the first metal frame and substantially perpendicular to the first side wall; a third side wall, disposed at the other end of the first side wall opposite to the second side wall and substantially perpendicular to the first side wall; a fourth side wall, substantially parallel to the first side wall, wherein the first side wall and the fourth side wall are disposed at two opposite end of the second side wall; and a fifth side wall, connected between the third side wall and the fourth side wall. A length of the third side wall in a direction substantially perpendicular to the first side wall is less than a length of the second side wall in the direction substantially perpendicular to the first side wall. A length of the fourth side wall in a direction substantially perpendicular to the second side wall is less than a length of the first side wall in the direction substantially perpendicular to the second side wall.

In some embodiments, the third side walls of the pair of first radiating arms are disposed oppositely to each other, such that the pair of first radiating arms of each first radiating element are spaced apart from each other at a constant distance at one end close to the third side wall. The pair of first radiating arms of each first radiating element are spaced apart from each other at one end adjacent to the fifth side wall at a distance gradually increased from one end of the fifth side wall connected to the third side wall to another end of the fifth side wall connected to the fourth side wall to form the horn-shaped opening.

In some embodiments, the first metal frame defines a hollow groove, one end of each of the pair of first radiating elements at which the first side walls are located passes through the hollow groove, and the second side walls of the pair of first radiating arms of the first radiating element are respectively attached to two opposite side walls of the hollow groove.

In some aspects, an antenna module may be further disclosure. The antenna module may include a plurality of the antenna units distributed in an array, and the each of the plurality of antenna units are the antenna units as previously described. The first circuit boards of the plurality of antenna units are integrated with each other.

In some embodiments, the first radiating elements of the plurality of antenna units are arranged in an N*N plane array. In any row and any column of the N*N plane array, any two adjacent first slots have unequal lengths, and two first slots adjacent to any first radiating element have equal lengths.

In some embodiments, the feeding posts of (N-2)*(N-2) first radiating elements in a center of the N*N plane array are electrically connected to an external power source to form an active region. The feeding posts of the first radiating elements around the (N-2)*(N-2) first radiating elements in the center of the N*N plane array are electrically connected to a matching load to form a passive region.

In some embodiments, the antenna module further comprises: a second circuit board, disposed at one side of the first circuit board away from the first radiating element, and a radio frequency front end, disposed at one side of the second circuit board away from the first circuit board; wherein the radio frequency front end comprises a phase shifter configured to shift a phase of the plurality of antenna units.

In some embodiments, the phase shifter comprises a plurality of phase shifting chips, some of the first radiating element arrays are arranged in an array to form a radiating element group, and each radiating element group is electrically connected to a corresponding one of the phase shifting chips.

In some aspects, an electronic device may be further disclosure. The electronic device may include a housing and the antenna module as previously described. The antenna module may be disposed in the housing.

### BRIEF DESCRIPTION OF THE DRAWINGS

FIG. 1 is an exploded view of an antenna unit according to some embodiments of the present disclosure.

FIG. 2 is a top view of the antenna unit according to some embodiments of the present disclosure.

FIG. 3 is a schematic view showing cooperation between a first radiating element and a first metal frame according to some embodiments of the present disclosure.

FIG. 4 is an exploded view of a first circuit board according to some embodiments of the present disclosure.

FIG. 5 is an exploded view of an antenna module with the antenna units arranged in a 10*10 array according to some embodiments of the present disclosure.

FIG. 6 is a top view of a first circuit board of the antenna module with the antenna units arranged in a 10*10 array according to some embodiments of the present disclosure.

FIG. 7 is a schematic view viewed from one angle and showing cooperation among the first circuit board, a second circuit board, and a phase shifter of the antenna module with antenna units arranged in a 10*10 array according to some embodiments of the present disclosure.

FIG. 8 is a bottom view showing cooperation among the first circuit board, a second circuit board, and a phase shifter of the antenna module with antenna units arranged in a 10*10 array according to some embodiments of the present disclosure.

FIG. 9 is a top view of the antenna module with the antenna units arranged in a 10*10 array according to some embodiments of the present disclosure.

FIG. 10a is a curve graph of reflection coefficients of individual antenna units Nos. 25-28 of the antenna module with the antenna units arranged in a 10*10 array according to some embodiments of the present disclosure.

FIG. 10b is a curve graph of degrees of isolation between individual antenna units Nos. 25-28 of the antenna module with the antenna units arranged in a 10*10 array according to some embodiments of the present disclosure.

FIG. 11a is a curve graph of reflection coefficients of individual antenna units Nos. 4, 12, 20, and 28 of the antenna module with the antenna units arranged in a 10*10 array according to some embodiments of the present disclosure.

FIG. 11b is a curve graph of degrees of isolation between individual antenna units Nos. 4, 12, 20, and 28 of the antenna module with the antenna units arranged in a 10*10 array according to some embodiments of the present disclosure.

FIG. 12a is a view illustrating a gain of a single antenna unit No. 27 of the antenna module with the antenna units arranged in a 10*10 array in a plane having Phi=0° at a frequency of 24.25 GHz according to some embodiments of the present disclosure.

FIG. 12b is a view illustrating a gain of a single antenna unit No. 27 of the antenna module with the antenna units arranged in a 10*10 array in a plane having Phi=90° at a frequency of 24.25 GHz according to some embodiments of the present disclosure.

FIG. 13a is a view illustrating a gain of a single antenna unit No. 27 of the antenna module with the antenna units arranged in a 10*10 array in a plane having Phi=0° at a frequency of 26 GHz according to some embodiments of the present disclosure.

FIG. 13b is a view illustrating a gain of a single antenna unit No. 27 of the antenna module with the antenna units arranged in a 10*10 array in a plane having Phi=90° at a frequency of 26 GHz according to some embodiments of the present disclosure.

FIG. 14a is a view illustrating a gain of a single antenna unit No. 27 of the antenna module with the antenna units arranged in a 10*10 array in a plane having Phi=0° at a frequency of 27.5 GHz according to some embodiments of the present disclosure.

FIG. 14b is a view illustrating a gain of a single antenna unit No. 27 of the antenna module with the antenna units arranged in a 10*10 array in a plane having Phi=90° at a frequency of 27.5 GHz according to some embodiments of the present disclosure.

FIG. 15a is a view illustrating a gain of a single antenna unit No. 28 of the antenna module with the antenna units arranged in a 10*10 array in a plane having Phi=0° at a frequency of 24.25 GHz according to some embodiments of the present disclosure.

FIG. 15b is a view illustrating a gain of a single antenna unit No. 28 of the antenna module with the antenna units arranged in a 10*10 array in a plane having Phi=90° at a frequency of 24.25 GHz according to some embodiments of the present disclosure.

FIG. 16a is a view illustrating a gain of a single antenna unit No. 28 of the antenna module with the antenna units arranged in a 10*10 array in a plane having Phi=0° at a frequency of 26 GHz according to some embodiments of the present disclosure.

FIG. 16b is a view illustrating a gain of a single antenna unit No. 28 of the antenna module with the antenna units arranged in a 10*10 array in a plane having Phi=90° at a frequency of 26 GHz according to some embodiments of the present disclosure.

FIG. 17a is a view illustrating a gain of a single antenna unit No. 28 of the antenna module with the antenna units arranged in a 10*10 array in a plane having Phi=0° at a frequency of 27.5 GHz according to some embodiments of the present disclosure.

FIG. 17b is a view illustrating a gain of a single antenna unit No. 28 of the antenna module with the antenna units arranged in a 10*10 array in a plane having Phi=90° at a frequency of 27.5 GHz according to some embodiments of the present disclosure.

FIG. 18a is a view illustrating a gain of the antenna module with the antenna units arranged in a 10*10 array in a plane having Phi=0° and in case that all the antenna units have phase differences therebetween at a frequency of 24.25 GHz according to some embodiments of the present disclosure.

FIG. 18b is a view illustrating a gain of the antenna module with the antenna units arranged in a 10*10 array in a plane having Phi=90° and in case that all the antenna units have phase differences therebetween at a frequency of 24.25 GHz according to some embodiments of the present disclosure.

FIG. 19a is a view illustrating a gain of the antenna module with antenna units arranged in a 10*10 array in a plane having Phi=0° and in case that all the antenna units have phase differences therebetween at a frequency of 26 GHz according to some embodiments of the present disclosure.

FIG. 19b is a view illustrating a gain of the antenna module with the antenna units arranged in a 10*10 array in a plane having Phi=90° and in case that all the antenna units have phase differences therebetween at a frequency of 26 GHz according to some embodiments of the present disclosure.

FIG. 20a is a view illustrating a gain of the antenna module with the antenna units arranged in a 10*10 array in a plane having Phi=0° and in case that all the antenna units have phase differences therebetween at a frequency of 27.5 GHz according to some embodiments of the present disclosure.

FIG. 20b is a view illustrating a gain of the antenna module with the antenna units arranged in a 10*10 array in a plane having Phi=90° and in case that all the antenna units have phase differences therebetween at a frequency of 27.5 GHz according to some embodiments of the present disclosure.

In the figures:

10, antenna unit; 100, antenna module; 1, first circuit board; 111, first slot; 112, feeding post; 113, feeding line; 114, through hole; 12, first grounding layer; 13, first grounding spacer; 14, second grounding layer; 15, second grounding spacer; 16, third grounding layer; 17, third grounding spacer; 18, fourth grounding layer; 191, first clearance region; 192, second clearance region; 193, third clearance region;

2, a first metal frame; 21, a hollow groove;

3, a first radiating element; 30, radiating element group; 31, first radiating arm; 311, first side wall; 312, second side wall; and 313, third side wall; and 314, fourth side wall; 315, fifth side wall; 316, relief groove;

4, phase shifter; 41, phase shifting chip;

5, second circuit board;

6, active region;

7, passive region.

### DETAILED DESCRIPTION

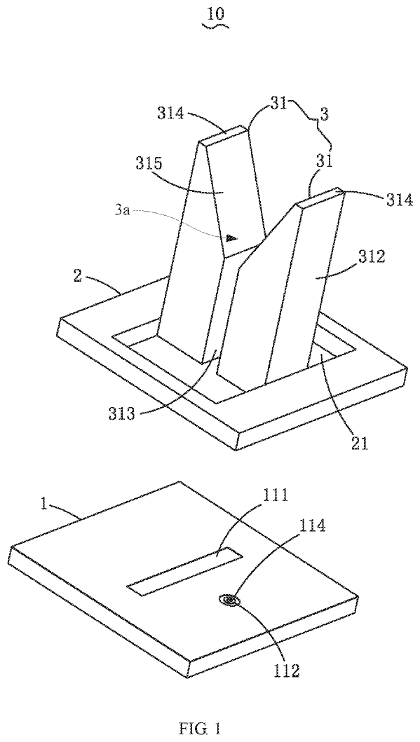

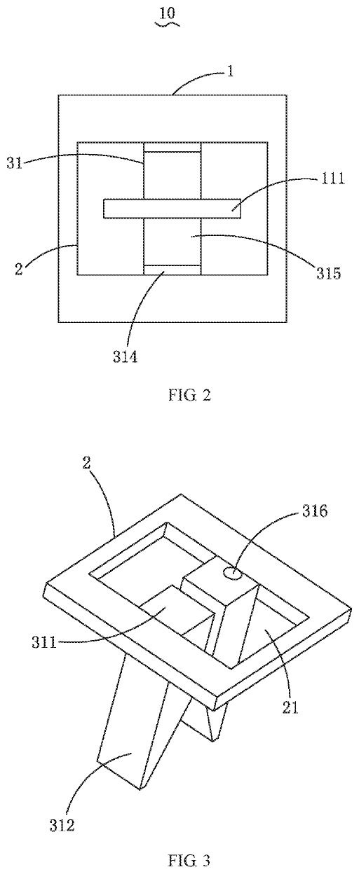

The present disclosure will be further described below with reference to FIGS. 1 to 20.

As shown in FIG. 1 to FIG. 9, according to some embodiments of the present disclosure, an antenna unit 10 may be disclosed. The antenna unit 10 may include a first circuit board 1, a first metal frame 2, and a first radiating element 3. The first radiating element 3 and the first metal frame 2 may be stacked or disposed on the first circuit board 1. Besides, the first metal frame 2 may be disposed around or enclose an outer periphery of the first radiating element 3. The first radiating element 3 may include a pair of first radiating arms 31 disposed opposite to each other and spaced apart from each other. The pair of first radiating arms 31 may be respectively attached to two opposite inner surfaces of the first metal frame 2. A system ground and a feeding structure may be formed on the first circuit board 1. Both the first radiating element 3 and the first metal frame 2 may be electrically connected to the system ground. In some embodiments, a horn-shaped opening 3a may be defined between the pair of first radiating arms 31 of the first radiating element 3.

In some embodiments, each first radiating arm 31 may include a first side wall 311, a second side wall 312, a third side wall 313, a fourth side wall 314, and a fifth side wall 315. The second side wall 312 may be disposed at one end of the first side wall 311 adjacent to the first metal frame 2, and substantially perpendicular to the first side wall 311. The third side wall 313 may be disposed at the other end of the first side wall 311 opposite to the second side wall 312, and substantially perpendicular to the first side wall 311. The fourth side wall 314 may be substantially parallel to the first side wall 311, and have one end connected to one end of the second side wall 312 away from the first side wall 311. That is to say, the first side wall 311 and the fourth side wall 314 may be disposed at two opposite end of the second side wall 312. The fifth side wall 315 may be connected between the third side wall 313 and the fourth side wall 314. A length of the third side wall 313 in a direction substantially perpendicular to the first side wall 311 may be less than a length of the second side wall 312 in the direction substantially perpendicular to the first side wall 311. A length of the fourth side wall 314 in a direction substantially perpendicular to the second side wall 312 may be less than a length of the first side wall 311 in the direction substantially perpendicular to the second side wall 312. The third side walls 313 of the pair of first radiating arms 31 may be disposed oppositely to each other, such that the pair of first radiating arms 31 of each first radiating element 3 may be spaced apart from each other at a constant distance at one end close to or near the third side wall 313. Furthermore, the pair of first radiating arms 31 of each first radiating element 3 may be spaced apart from each other at one end close or adjacent to the fifth side wall 315 at a distance gradually increased from one end of the fifth side wall 315 connected to the third side wall 313 to another end of the fifth side wall 315 connected to the fourth side wall 314, thereby forming the horn-shaped opening 3a. It should be noted that, in some embodiments of the present disclosure, the fifth side wall 315 will not be limited to have the planar configuration as shown in FIG. 1. In other embodiments, the fifth side wall 315 may have a curved configuration. In addition, in other embodiments, the first radiating arm 31 may also have a planar configuration. The first radiating element 3 may be made of metal materials.

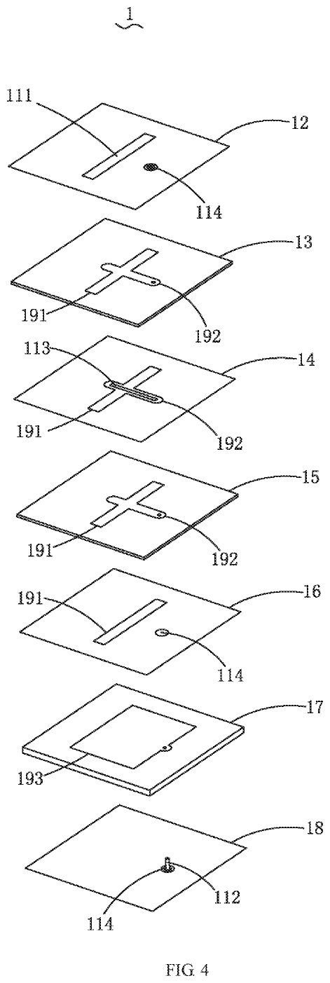

As shown in FIG. 4, the first circuit board 1 may include a first grounding layer 12, a first grounding spacer 13, a second grounding layer 14, a second grounding spacer 15, and a third grounding layer 16 subsequently stacked on one another. The first grounding layer 12 may define a first slot 111. The first grounding spacer 13, the second grounding layer 14, the second grounding spacer 15, and the third grounding layer 16 may each define a first clearance region 191 thereon, and the first clearance region 191 on each of the first grounding spacer 13, the second grounding layer 14, the second grounding spacer 15, and the third grounding layer 16 may be disposed correspondingly to the first slot 111. The first grounding spacer 13, the second grounding layer 14, and the second grounding spacer 15 may each further define a second clearance region 192 that is perpendicularly intersected and communicated with the first clearance region 191 on the first grounding spacer 13, the second grounding layer 14, and the second grounding spacer 15, respectively. The first circuit board 1 may further include a feeding line 113 received in the second clearance region 192 of the second grounding layer 14 and a feeding post 112 running through the first circuit board 1. The feeding post 112 may be connected to one end of the feeding line 113, and may be electrically isolated from the first grounding layer 12, the second grounding layer 14, and the third grounding layer 16. The first metal frame 2 and the first radiating element 3 may be disposed above or disposed on the first grounding layer 12. The pair of first radiating arms 31 of the first radiating element 3 may be symmetrically arranged at two opposite sides in a width direction of the first slot 111. One of the first radiating arms 31 may cover above or on the feeding post 112, and one end of the aforesaid first radiating arm 31 facing the feeding post 112 may define a relief groove 316 configured to provide a clearance space or a relief space for the feeding post 112. By defining the relief groove 316, it is possible to reduce the possibility that the feeding post 112 is electrically connected to the first radiating arm 31, thereby reducing the possibility that a direct short occurs between the first circuit board 1 and the first radiating element 3.

The first circuit board 1 may further include a third grounding spacer 17 and a fourth grounding layer 18. The third grounding spacer 17 may be disposed at one side of the third grounding layer 16 away from the second grounding spacer 15. The fourth grounding layer 18 may be disposed at one side of the third grounding spacer 17 away from the third grounding layer 16. The third grounding spacer 17 may define a third clearance region 193. Orthographic projections of the first clearance region 191 and the second clearance region 192 projected on the third grounding spacer 17 may all disposed within the third clearance region 193. The third grounding layer 16, the third grounding spacer 17, the third clearance region 193, and the fourth grounding layer 18 may cooperatively define a rear chamber of the antenna unit 10. The rear chamber may completely cover the first slot 111, in order to reduce the possibility of the electric leakage caused by the first slot 111, reduce the radiation from a rear side of the first radiating element 3, reduce a level of a rear lobe, and further increase a gain of the antenna unit 10.

In some embodiments, the feeding post 112 may pass through or run through the third clearance region 193 and may be electrically isolated from the fourth grounding layer 18.

In some embodiments, the first grounding spacer 13, the second grounding spacer 15, and the third grounding spacer 17 may be implemented as a dielectric substrate. The first grounding layer 12, the second grounding layer 14, the third grounding layer 16, and the fourth grounding layer 18 may be a metal layer covering a surface of the dielectric substrate. The first grounding layer 12, the second grounding layer 14, the third grounding layer 16, and the fourth grounding layer 18 may be electrically connected to each other via metallized vias defined in the dielectric substrates, respectively. The first slot 111, the first clearance region 191, and the second clearance region 192 located in each metal layer may be formed by etching the each corresponding metal layer or performing other processes on each corresponding metal layer. The feeding line 113 may be a pattern retained or formed on the second grounding layer 14 when etching the second grounding layer 14 to form the second clearance region 192. The third clearance region 193 may be implemented as a region in which no metallized vias that is electrically connected the third grounding layer 16 and the fourth grounding layer 18 is defined. In some embodiments, the third clearance region 193 may also be implemented by defining a through groove on the dielectric substrate, and further filling the through groove with a dielectric having a dielectric constant different from that of the third grounding spacer 17.

The first slot 111, the first clearance region 191, the second clearance region 192, the feeding line 113, and the feeding post 112 may form the feeding structure of the first circuit board 1. Conductive portions of the first grounding layer 12, the first grounding spacer 13, the second grounding layer 14, the second grounding spacer 15, the third grounding layer 16, the third grounding spacer 17, and the fourth grounding layer 18 form the system ground of the first circuit board 1, respectively.

In some embodiments, the first circuit board 1 may define a through hole 114 penetrating or running through the spacers. The feeding post 112 may penetrate through the through hole 114 and may be further electrically connected to one end of the feeding line 113. More specifically, the feeding post 112 may sequentially pass through the four grounding layer 18, the third grounding spacer 17, the third grounding layer 16, the second grounding spacer 15, the second grounding layer 14, the first grounding spacer 13, and the first grounding layer 12, and may be electrically isolated from the first grounding layer 12, the second grounding layer 14, the third grounding layer 16, and the fourth grounding layer 18. In some embodiments, the first grounding spacer 13 may have a thickness substantially equal to that of the second grounding spacer 15. The third grounding spacer 17 may have a thickness 2.5 times the thickness of the first grounding spacer 13.

In some embodiments, the first metal frame 2 may define a hollow groove 21. One end of the first radiating element 3 at which the first side wall 311 is located may pass through the hollow groove 21, and the second side walls 312 of the pair of first radiating arms 31 of the first radiating element 3 may be respectively attached to two opposite side walls of the hollow groove 21. More specifically, the hollow groove 21 and the first slot 111 may be both rectangular grooves. A length direction of the hollow groove 21 may be the same as a length direction of the first slot 111. The first slot 111 may be arranged directly opposite to or facing a central position of the hollow groove 21. The second side walls 312 of the pair of first radiating arms 31 of each first radiating element 3 may be respectively attached to middle portions of two long side walls of the hollow groove 21 that are opposite to each other. A distance between the pair of first radiating arms 31 may be substantially equal to a width of the first slot 111. By providing the first metal frame 2 having the hollow groove 21, the first radiating element 3 may be quickly and accurately arranged at the feeding structure of the first circuit board 1, and the arrangement speed and efficiency of the antenna unit 10 may be improved.

In some embodiments of the present disclosure, an antenna module 100 including the above-described antenna unit 10 may be further provided. The antenna module 100 may include a plurality of antenna units 10 arranged in an array. The first circuit boards 1 of the plurality of antenna units 10 may be integrated with each other.

In some embodiments, the first radiating elements 3 of the plurality of antenna units 10 may be arranged in an N*N plane array. Besides, in any row and any column of the N*N plane array, every two adjacent first slots 111 of the plurality of antenna units 10 may have unequal lengths. Furthermore, two first slots 111 adjacent to any first radiating element 3 may have the same length.

In some embodiments, the feeding posts 112 of (N-2)*(N-2) first radiating elements 3 in a center of the N*N plane array may be electrically connected to an external power source to form an active region 6. The feeding posts 112 of the first radiating elements 3 around the (N-2)*(N-2) first radiating elements 3 in the center of the N*N plane array may be electrically connected to a matching load to form a passive region 7.

As shown in FIG. 5, the antenna module 100 may be arranged in a 10*10 array. The active region 6 may include 64 first radiating elements 3 arranged in an 8*8 array. The passive region 7 may include 36 first radiating elements 3 surrounding the active region 6. The pair of first radiating arms 31 of each first radiating element 3 may be substantially perpendicular to the first circuit board 1, so as to form a phased array in combination with other first radiating elements 3, thereby increasing the gain of the antenna module 100 and increasing a bandwidth of the antenna module 100.

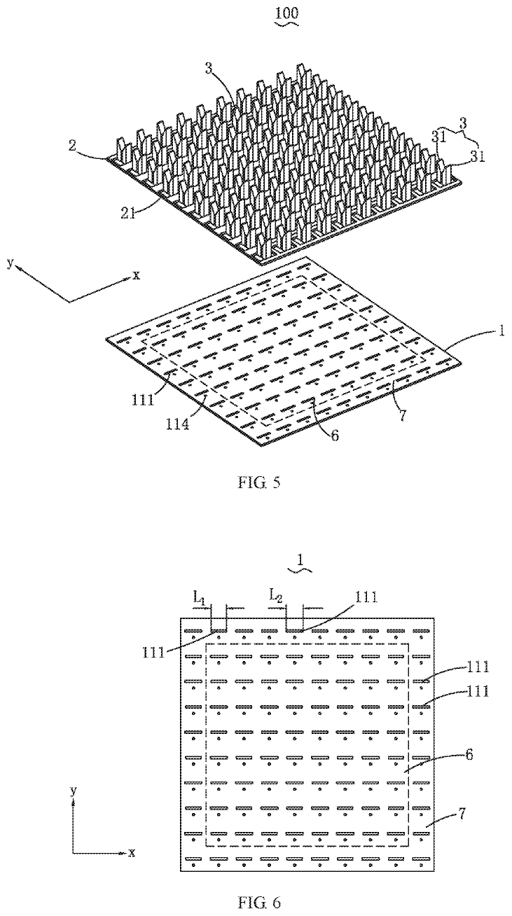

As shown in FIG. 6, in some embodiments, the first slots 111 of the plurality of antenna units 10 may include a plurality of first sub-slots 111 having a length of L1 and a plurality of second sub-slots 111 having a length of L2. L1 may not be equal to L2, and L1 and L2 may be each less than a length of the hollow groove 21. More specifically, a ratio of L1 to L2 may be 0.9.

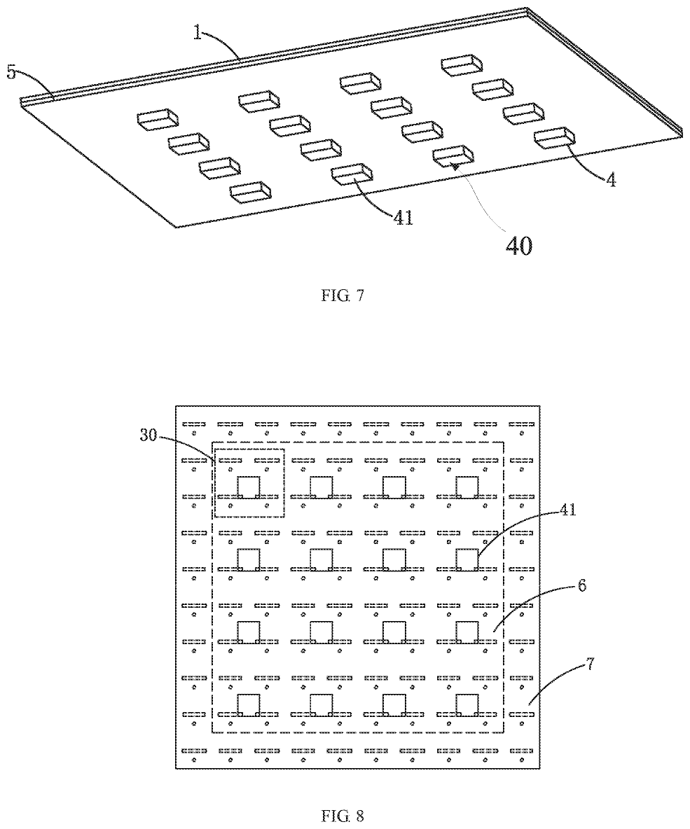

As shown in FIGS. 7 and 8, the antenna module 100 may further include a second circuit board 5 disposed at one side of the first circuit board 1 away from the first radiating element 3, and a radio frequency front end 40 disposed at one side of the second circuit board 5 away from the first circuit board 1. The radio frequency front end 40 may include a phase shifter 4 configured to shift a phase of the corresponding antenna unit 10. Each of the first radiating elements 3 may be electrically connected to the phase shifter 4. The phase shifter 4 may be configured to provide a phase difference to the first radiating elements 3. In this way, it is possible to direct a radiation mode of the antenna module 100 in a desired coverage angle, keep the line-of-sight communication between the transmitter and receiver uninterrupted, and increase the total gain. More specifically, the phase shifter 4 may be configured to distribute the phases of the first radiating elements 3 according to or based on a certain principle, thereby forming a high-gain beam. Besides, the phase shifter 4 may be further configured to direct a radiation mode of the antenna module 100 in a desired coverage angle by changing the phase shift to make the beam to perform the scan in a certain spatial range. In this way, it is possible to keep the line-of-sight communication between the transmitter and receiver uninterrupted, thereby improving the reliability of the antenna module 100.

The phase shifter 4 may include a plurality of phase shifting chips 41. Several first radiating elements 3 may be arranged in an array to form a radiating element group 30. Each radiating element group 30 may be electrically connected to one phase shifting chip 41 correspondingly. In some embodiments, each radiating element group 30 may include four adjacent first radiation elements 3 arranged in a 2*2 array on the first grounding layer 12.

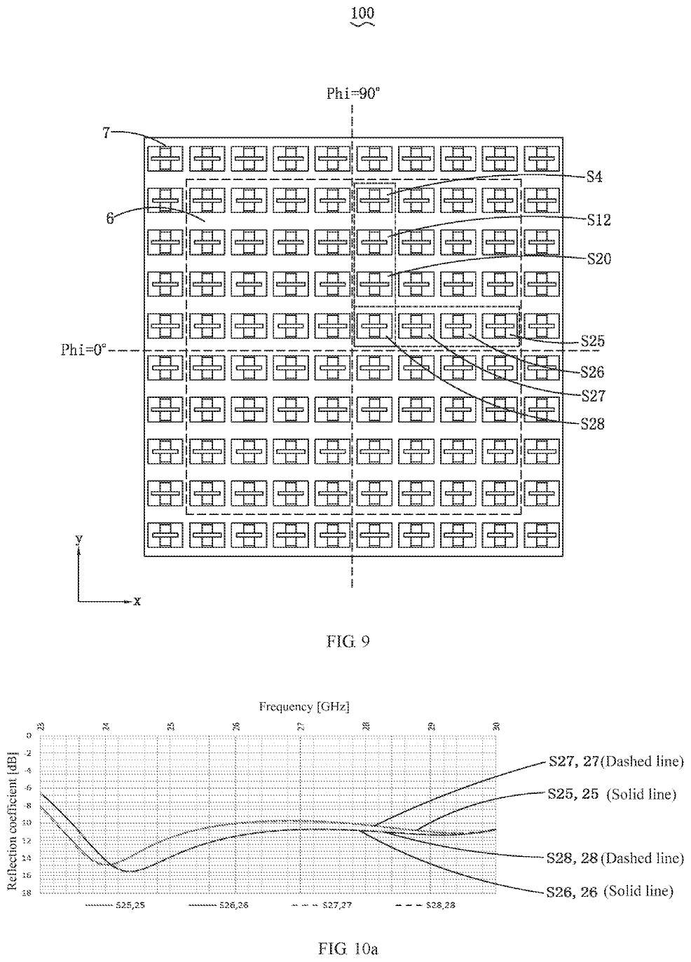

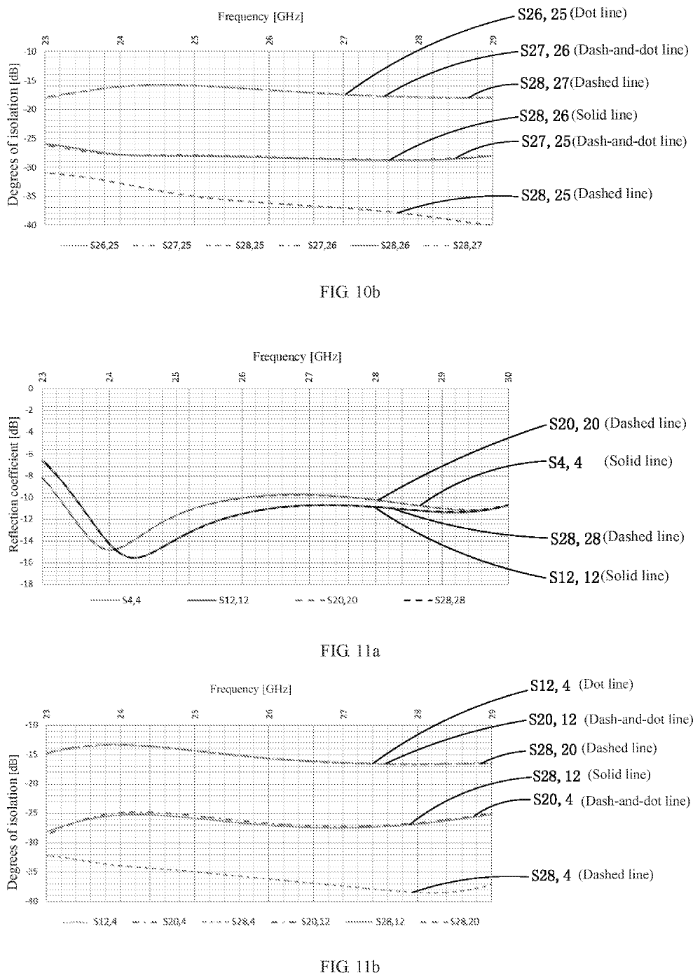

FIG. 9 is a top view of the antenna module 100 with the antenna units 10 arranged in a 10*10 array according to some embodiments of the present disclosure. The antenna units 10 in the active region 6 may be numbered. In some embodiments, the 25^{th}, 26^{th}, 27^{th}, and 28^{th} single antenna units 10 may be represented by S25, S26, S27, and S28, respectively. The 4^{th}, 12^{th}, and 20^{th} single antenna units 10 may be represented by S4, S12 and S20 respectively. FIG. 10a is a curve graph of reflection coefficients of individual antenna units 10 Nos. 25-28 of the antenna module 100 with antenna units 10 arranged in a 10*10 array according to some embodiments of the present disclosure. In some embodiments the lengths of the first slots 111 of the antenna units 10 Nos. 25 and 27 may be L2, and the lengths of the first slots 111 of the antenna units 10 Nos. 26 and 28 may be L1. It may be seen from FIG. 10a that, the 25^{th} and 27^{th} antenna units 10 may have the same reflection coefficients, and the 26^{th} and 28^{th} antenna units 10 may have the same reflection coefficients. Since the length L1 may be less than the length L2, compared with the curves illustrating the reflection coefficients of the antenna units 10 No. 26 and No. 28, the curves illustrating the reflection coefficients of the antenna units 10 No. 25 and No. 27 may be slightly biased towards low frequencies. FIG. 10b is a curve graph of degrees of isolation between individual antenna units 10 Nos. 25-28 of the antenna module 100 with antenna units 10 arranged in a 10*10 array according to some embodiments of the present disclosure. It may be seen from FIG. 10b that, the degree of isolation between two adjacent single antenna units 10 is the worst, that is to say, the degree of isolation between the antenna units 10 No. 25 and No. 26, the degree of isolation between the antenna units 10 No. 26 and No. 27, and the degree of isolation between the antenna units 10 No. 27 and No. 28 are the worst, and the worst degree of isolation may reach −15.76 dB.

FIG. 11a is a curve graph of reflection coefficients of individual antenna units 10 Nos. 4, 12, 20, and 28 of the antenna module 100 with antenna units arranged in a 10*10 array according to some embodiments of the present disclosure. In some embodiments, the lengths of the first slots 111 of the antenna units 10 Nos. 4 and 20 may be L2, and the lengths of the first slots 111 of the antenna units 10 Nos. 12 and 28 may be L1. It may be seen from FIG. 11a that, the 4^{th} and 20^{th} antenna units 10 may have the same reflection coefficients, and the 12^{th} and 28^{th} antenna units 10 may have the same reflection coefficients. Since the length L1 may be less than the length L2, compared with the curves illustrating the reflection coefficients of the antenna units 10 No. 12 and No. 28, the curves illustrating the reflection coefficients of the antenna units 10 No. 4 and No. 20 may be slightly biased towards low frequencies. FIG. 11b is a curve graph of degrees of isolation between individual antenna units 10 Nos. 4, 12, 20, and 28 of the antenna module 100 with antenna units 10 arranged in a 10*10 array according to some embodiments of the present disclosure. It may be seen from FIG. 1 lb that, the degree of isolation between two adjacent single antenna units 10 is the worst, that is to say, the degree of isolation between the antenna units 10 No. 4 and No. 12, the degree of isolation between the antenna units 10 No. 12 and No. 20 and the degree of isolation between the antenna units 10 No. 20 and No. 28 are the worst, and the worst degree of isolation may reach −13.45 dB. Compared with the degrees of isolation between every two adjacent antenna units 10 Nos. 25-28 shown in FIG. 10b, the degrees of isolation between every two adjacent antenna units 10 Nos. 4, 12, 20, and 28 shown in FIG. 11b may be worse.

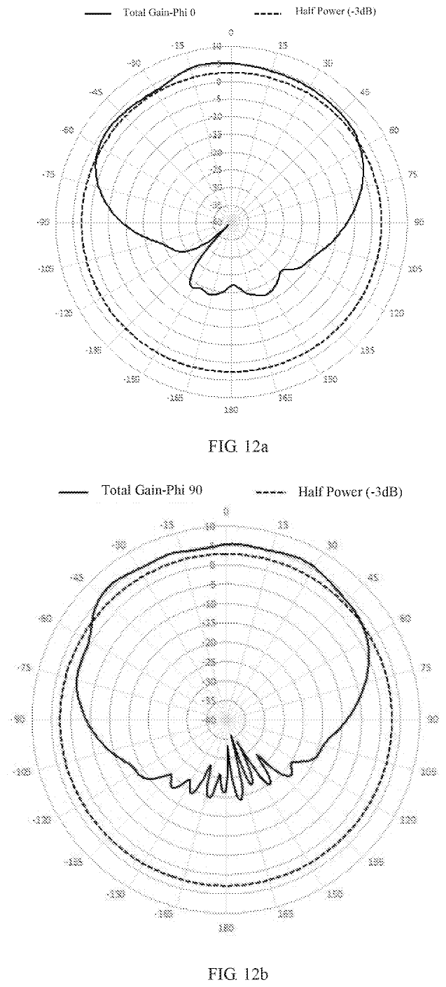

FIG. 12a is a view illustrating a gain of a single antenna unit 10 No. 27 of the antenna module 100 with antenna units 10 arranged in a 10*10 array in a plane having Phi=0° at a frequency of 24.25 GHz according to some embodiments of the present disclosure. FIG. 12b is a view illustrating a gain of a single antenna unit 10 No. 27 of the antenna module 100 with antenna units 10 arranged in a 10*10 array in a plane having Phi=90° at a frequency of 24.25 GHz according to some embodiments of the present disclosure. It may be seen from FIGS. 12a and 12b that, the single antenna unit 10 No. 27 may have a half-power beam width (HPBW) with a width greater than 90° (θ: −45°˜+45° and a gain value of a main beam of 5.32 dBi.

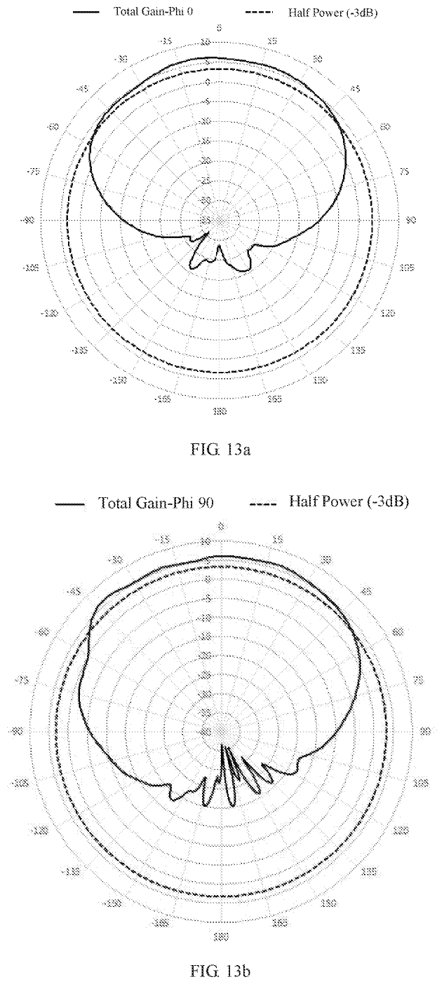

FIG. 13a is a view illustrating a gain of a single antenna unit 10 No. 27 of the antenna module 100 with antenna units 10 arranged in a 10*10 array in a plane having Phi=0° at a frequency of 26 GHz according to some embodiments of the present disclosure. FIG. 13b is a view illustrating a gain of a single antenna unit 10 No. 27 of the antenna module 100 with antenna units 10 arranged in a 10*10 array in a plane having Phi=90° at a frequency of 26 GHz according to some embodiments of the present disclosure. It may be seen from FIGS. 13a and 13b that, the single antenna unit 10 No. 27 may have a HPBW with a width greater than 90° (θ: −45°˜+45° and a gain value of a main beam of 6.08 dBi.

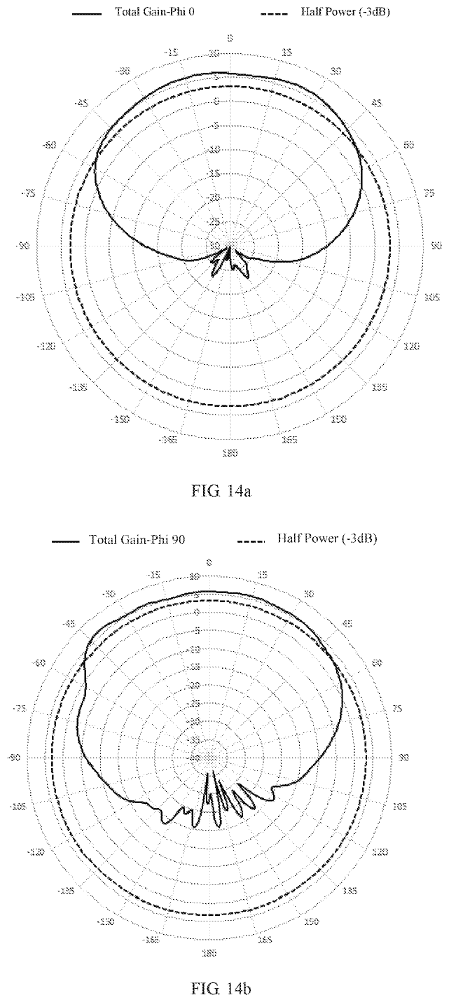

FIG. 14a is a view illustrating a gain of a single antenna unit 10 No. 27 of the antenna module 100 with antenna units 10 arranged in a 10*10 array in a plane having Phi=0° at a frequency of 27.5 GHz according to some embodiments of the present disclosure. FIG. 14b is a view illustrating a gain of a single antenna unit 10 No. 27 of the antenna module 100 with antenna units 10 arranged in a 10*10 array in a plane having Phi=90° at a frequency of 27.5 GHz according to some embodiments of the present disclosure. It may be seen from FIGS. 14a and 14b that, the single antenna unit 10 No. 27 may have a HPBW with a width greater than 90° (θ: −45°˜+45° and a gain value of a main beam of 5.77 dBi.

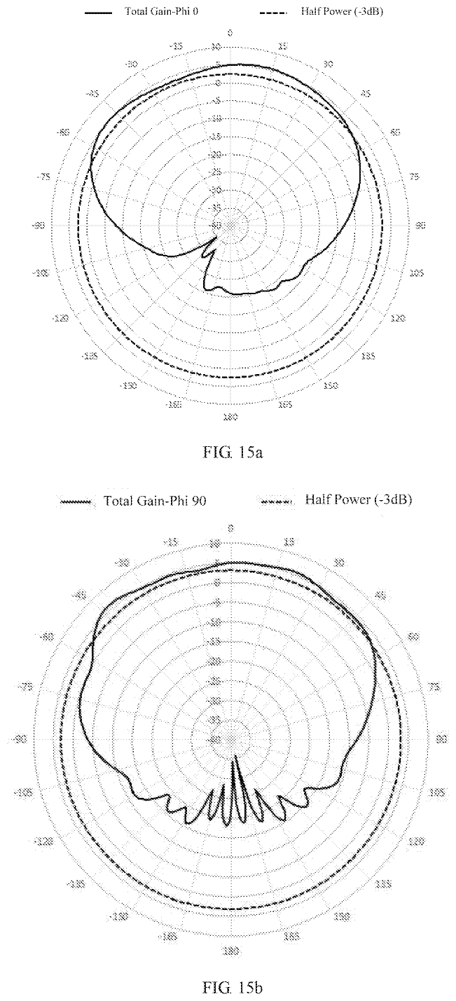

FIG. 15a is a view illustrating a gain of a single antenna unit 10 No. 28 of the antenna module 100 with antenna units 10 arranged in a 10*10 array in a plane having Phi=0° at a frequency of 24.25 GHz according to some embodiments of the present disclosure. FIG. 15b is a view illustrating a gain of a single antenna unit 10 No. 28 of the antenna module 100 with antenna units 10 arranged in a 10*10 array in a plane having Phi=90° at a frequency of 24.25 GHz according to some embodiments of the present disclosure. It may be seen from FIGS. 15a and 15b that, the single antenna unit 10 No. 28 may have a half-power beam width (HPBW) with a width greater than 90° (θ: −45°˜+45° and a gain value of a main beam of 5.09 dBi.

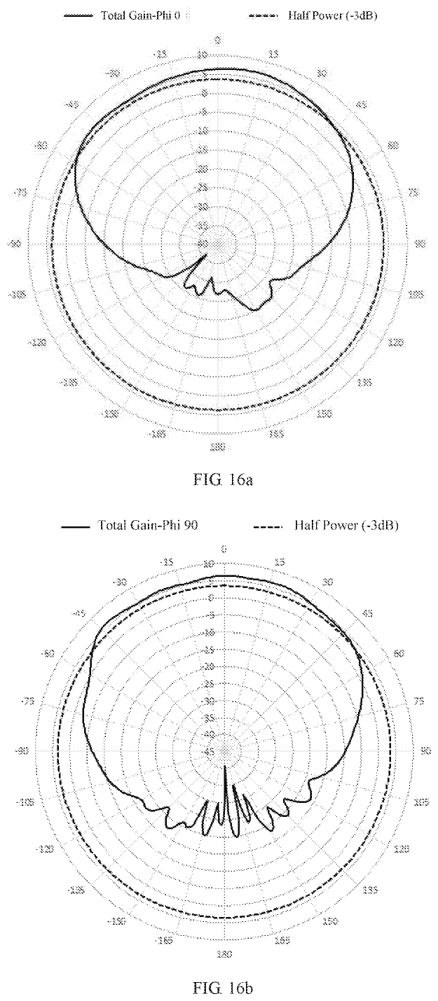

FIG. 16a is a view illustrating a gain of a single antenna unit 10 No. 28 of the antenna module 100 with antenna units 10 arranged in a 10*10 array in a plane having Phi=0° at a frequency of 26 GHz according to some embodiments of the present disclosure. FIG. 16b is a view illustrating a gain of a single antenna unit 10 No. 28 of the antenna module 100 with antenna units 10 arranged in a 10*10 array in a plane having Phi=90° at a frequency of 26 GHz according to some embodiments of the present disclosure. It may be seen from FIGS. 16a and 16b that, the single antenna unit 10 No. 28 may have a HPBW with a width greater than 90° (θ: −45°˜+45° and a gain value of a main beam of 6.47 dBi.

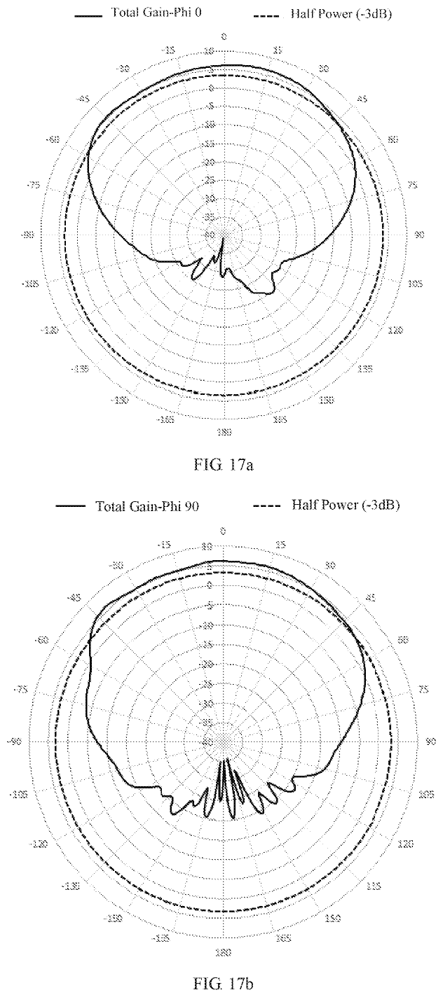

FIG. 17a is a view illustrating a gain of a single antenna unit 10 No. 28 of the antenna module 100 with antenna units 10 arranged in a 10*10 array in a plane having Phi=0° at a frequency of 27.5 GHz according to some embodiments of the present disclosure. FIG. 17b is a view illustrating a gain of a single antenna unit 10 No. 28 of the antenna module 100 with antenna units 10 arranged in a 10*10 array in a plane having Phi=90° at a frequency of 27.5 GHz according to some embodiments of the present disclosure. It may be seen from FIGS. 17a and 17b that, the single antenna unit 10 No. 28 may have a HPBW with a width greater than 90° (θ: −45°˜+45° and a gain value of a main beam of 6.18 dBi.

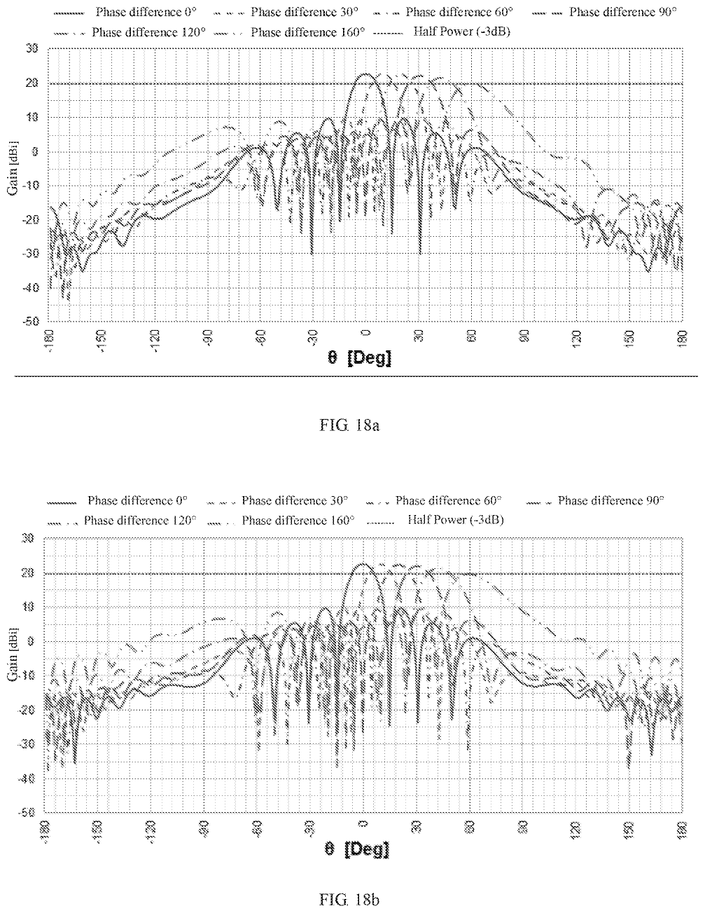

FIG. 18a is a view illustrating a gain of the antenna module 100 with antenna units 10 arranged in a 10*10 array in a plane having Phi=0° and in case that all the antenna units 10 have phase differences therebetween at a frequency of 24.25 GHz according to some embodiments of the present disclosure. FIG. 18b is a view illustrating a gain of the antenna module 100 with antenna units 10 arranged in a 10*10 array in a plane having Phi=90° and in case that all the antenna units 10 have phase differences therebetween at a frequency of 24.25 GHz according to some embodiments of the present disclosure. The phase differences between the corresponding antenna units 10 of the antenna module 100 in FIGS. 18a and 18b may be 0°, +30°, +60°, +90°, +120°, and +160°, respectively. FIGS. 18a and 18b only show the curve of the gain with the θ angle of a positive value. However, the curve of the gain with the θ angle of a negative value and the gain with the θ angle of a positive value may be displayed symmetrically with respect to θ=0°. It may be seen from the figures that, with the beam deviating from 0°, a peak of the gain will gradually decrease. This is a common phenomenon in phased array antennas. For example, in the plane of Phi=0°, when the beam is turned to θ=60° from θ=0°, the gain of the antenna may be reduced from 22.6 dBi to 19.75 dBi (the gain loss may be 2.85 dBi). In the plane of Phi=90°, when the beam is turned to θ=60° from θ=0°, the gain of the antenna may be reduced from 22.6 dBi to 19.72 dBi (the gain loss may be 2.88 dBi).

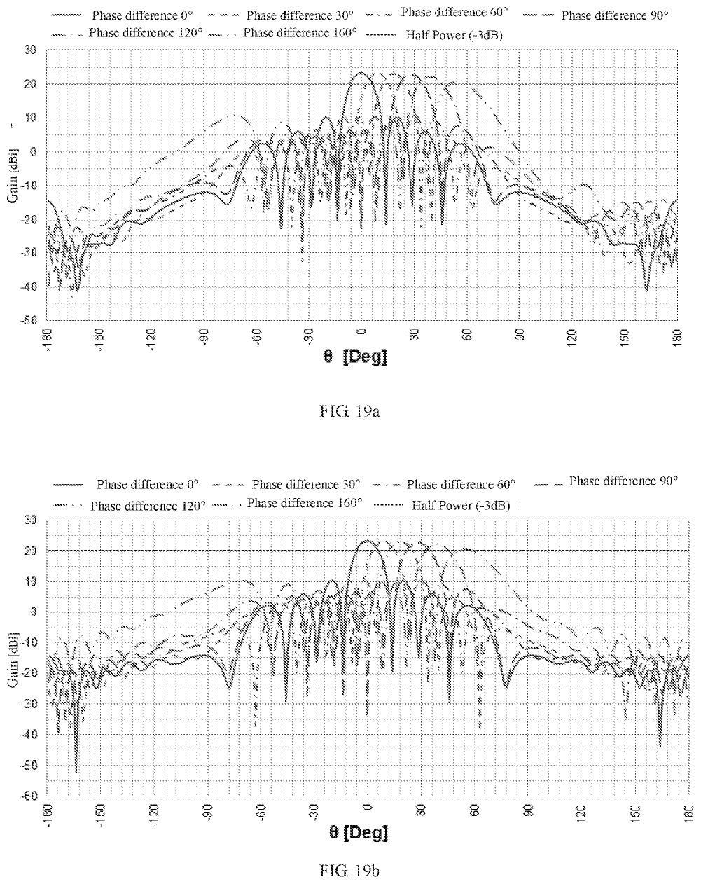

FIG. 19a is a view illustrating a gain of the antenna module 100 with antenna units 10 arranged in a 10*10 array in a plane having Phi=0° and in case that all the antenna units 10 have phase differences therebetween at a frequency of 26 GHz according to some embodiments of the present disclosure. FIG. 19b is a view illustrating a gain of the antenna module 100 with antenna units 10 arranged in a 10*10 array in a plane having Phi=90° and in case that all the antenna units 10 have phase differences therebetween at a frequency of 26 GHz according to some embodiments of the present disclosure. The phase differences between the corresponding antenna units 10 of the antenna module 100 in FIGS. 19a and 19b may be 0°, +30°, +60°, +90°, +120°, and +160°, respectively. FIGS. 19a and 19b only show the curve of the gain with the θ angle of a positive value. However, the curve of the gain with the θ angle of a negative value and the gain with the θ angle of a positive value may be displayed symmetrically with respect to θ=0°. It may be seen from the figures that, with the beam deviating from 0°, a peak of the gain will gradually decrease. This is a common phenomenon in phased array antennas. For example, in the plane of Phi=0°, when the beam is turned to θ=60° from θ=0°, the gain of the antenna may be reduced from 23.28 dBi to 19.82 dBi (the gain loss may be 3.46 dBi). In the plane of Phi=90°, when the beam is turned to θ=60° from θ=0°, the gain of the antenna may be reduced from 23.28 dBi to 19.73 dBi (the gain loss may be 3.55 dBi).

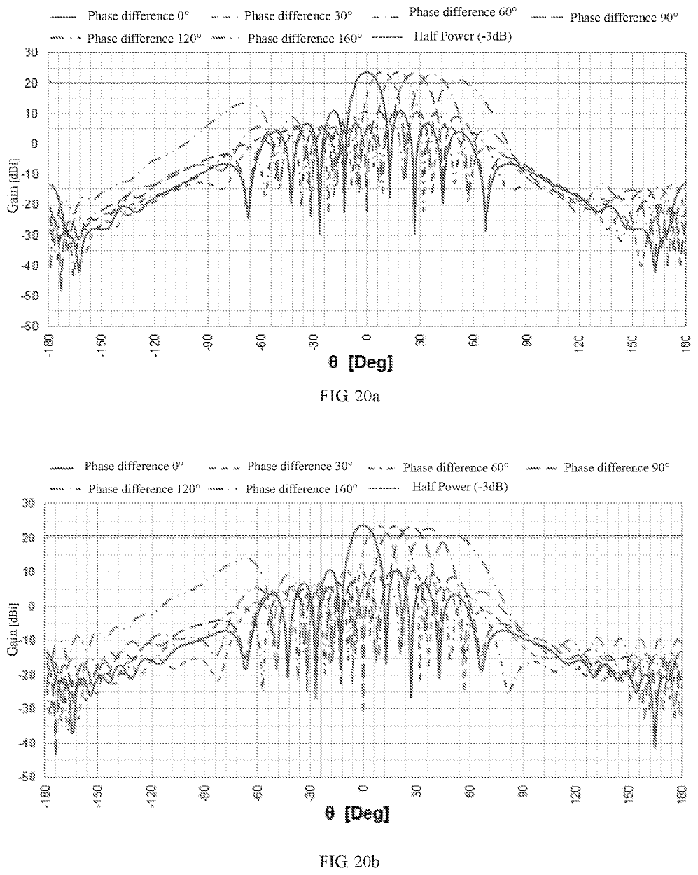

FIG. 20a is a view illustrating a gain of the antenna module 100 with antenna units 10 arranged in a 10*10 array in a plane having Phi=0° and in case that all the antenna units 10 have phase differences therebetween at a frequency of 27.5 GHz according to some embodiments of the present disclosure. FIG. 20b is a view illustrating a gain of the antenna module 100 with antenna units 10 arranged in a 10*10 array in a plane having Phi=90° and in case that all the antenna units 10 have phase differences therebetween at a frequency of 27.5 GHz according to some embodiments of the present disclosure. The phase differences between the corresponding antenna units 10 of the antenna module 100 in FIGS. 20a and 20b may be 0°, +30°, +60°, +90°, +120°, and +160°, respectively. FIGS. 20a and 20b only show the curve of the gain with the θ angle of a positive value. However, the curve of the gain with the θ angle of a negative value and the gain with the θ angle of a positive value may be displayed symmetrically with respect to θ=0°. It may be seen from the figures that, with the beam deviating from 0°, a peak of the gain will gradually decrease. This is a common phenomenon in phased array antennas. For example, in the plane of Phi=0°, when the beam is turned to θ=60° from θ=0°, the gain of the antenna may be reduced from 23.72 dBi to 18.43 dBi (the gain loss may be 5.29dBi). In the plane of Phi=90°, when the beam is turned to θ=60° from θ=0°, the gain of the antenna may be reduced from 23.72 dBi to 18.2 dBi (the gain loss may be 5.52 dBi).

In some embodiments of the present disclosure, an electronic device may also be disclosed. The electronic device may include the above-mentioned antenna module 100 provided in some embodiments of the present disclosure.

The above may be only the embodiments of the present disclosure. It should be pointed out here that for those skilled in the art, improvements may be made without departing from the inventive concept of the present disclosure. All these belong to the protection scope of by the present disclosure.

What is claimed is:

1. An antenna unit, comprising:
a first circuit board, wherein a system ground and a feeding structure are formed on the first circuit board;
a first metal frame, stacked on the first circuit board; and
a first radiating element, stacked on the first circuit board, wherein the first metal frame is arranged around an outer periphery of the first radiating element, the first radiating element comprises a pair of first radiating arms opposite to and spaced apart from each other, and the pair of first radiating arms are attached to two opposite inner surfaces of the first metal frame;
wherein both the first radiating element and the first metal frame are electrically connected to the system ground.

2. The antenna unit as claimed in claim 1, wherein a horn-shaped opening is defined between the pair of first radiating arms of the first radiating element.

3. The antenna unit as claimed in claim 1, wherein the first circuit board comprises a first grounding layer, a first grounding spacer, a second grounding layer, a second grounding spacer, and a third grounding layers subsequently stacked on one another;
the first grounding layer defines a first slot;
each of the first grounding spacer, the second grounding layer, the second grounding spacer, and the third grounding layer defines a first clearance region facing the first slot;
each of the first grounding spacer, the second grounding layer, and the second grounding spacer defines a second clearance region perpendicularly intersected and communicated with the corresponding first clearance region defined in the first grounding spacer, the second grounding layer, and the second grounding spacer;
the first circuit board further comprises:
a feeding line, received in the second clearance region defined in the second grounding layer; and
a feeding post, running through the first circuit board, electrically connected to the feeding line, and electrically isolated from the first grounding layer, the second grounding layer, and the third grounding layer;
wherein the first metal frame and the first radiating element are arranged above the first grounding layer, the pair of first radiating arms of the first radiating element are symmetrically arranged at two opposite sides in a width direction of the first slot;
one of the first radiating arms is arranged to cover the feeding post, the first radiating arm defines a relief groove at one end facing the feeding post, and the relief groove is configured to provide a clearance for the feeding post.

4. The antenna unit as claimed in claim 3, wherein the first circuit board further comprises a third grounding spacer and a fourth grounding layer;
wherein the third grounding spacer is disposed at one side of the third grounding layer away from the second grounding spacer, and the fourth grounding layer is disposed at one side of the third grounding spacer away from the third grounding layer;
the third grounding spacer defines a third clearance region, and orthographic projections of the first clearance region and the second clearance region projected on the third grounding spacer are all disposed within the third clearance region; and
the third grounding layer, the third grounding spacer, the third clearance region, and the fourth grounding layer cooperatively define a rear chamber of the antenna unit.

5. The antenna unit as claimed in claim 4, wherein the feeding post passes through the third clearance region and is electrically isolated from the fourth grounding layer.

6. The antenna unit as claimed in claim 4, wherein the third clearance region comprises a dielectric having a dielectric constant different from that of the third grounding spacer.

7. The antenna unit as claimed in claim 4, wherein the first circuit board defines a through hole running through the first, second, and third grounding spacers;
the feeding post passes through the through hole and is further electrically connected to one end of the feeding line.

8. The antenna unit as claimed in claim 4, wherein the first grounding spacer has a thickness substantially equal to that of the second grounding spacer, and the third grounding spacer has a thickness 2.5 times the thickness of the first grounding spacer.

9. The antenna unit as claimed in claim 1, wherein each of the pair of first radiating arms comprises:
a first side wall,
a second side wall, disposed at one end of the first side wall adjacent to the first metal frame and substantially perpendicular to the first side wall;
a third side wall, disposed at the other end of the first side wall opposite to the second side wall and substantially perpendicular to the first side wall;
a fourth side wall, substantially parallel to the first side wall, wherein the first side wall and the fourth side wall are disposed at two opposite end of the second side wall; and
a fifth side wall, connected between the third side wall and the fourth side wall;
wherein a length of the third side wall in a direction substantially perpendicular to the first side wall is less than a length of the second side wall in the direction substantially perpendicular to the first side wall;
a length of the fourth side wall in a direction substantially perpendicular to the second side wall is less than a length of the first side wall in the direction substantially perpendicular to the second side wall.

10. The antenna unit as claimed in claim 9, wherein the third side walls of the pair of first radiating arms are disposed oppositely to each other, such that the pair of first radiating arms of each first radiating element are spaced apart from each other at a constant distance at one end close to the third side wall;
the pair of first radiating arms of each first radiating element are spaced apart from each other at one end adjacent to the fifth side wall at a distance gradually increased from one end of the fifth side wall connected to the third side wall to another end of the fifth side wall connected to the fourth side wall to form the horn-shaped opening.

11. The antenna unit as claimed in claim 9, wherein the first metal frame defines a hollow groove, one end of each of the pair of first radiating elements at which the first side walls are located passes through the hollow groove, and the second side walls of the pair of first radiating arms of the first radiating element are respectively attached to two opposite side walls of the hollow groove.

12. An antenna module, comprising a plurality of the antenna units distributed in an array, wherein each of the plurality of antenna units comprises:
a first circuit board, wherein a system ground and a feeding structure are formed on the first circuit board;
a first metal frame, stacked on the first circuit board; and
a first radiating element, stacked on the first circuit board, wherein the first metal frame is arranged around an outer periphery of the first radiating element, the first radiating element comprises a pair of first radiating arms opposite to and spaced apart from each other, and the pair of first radiating arms are attached to two opposite inner surfaces of the first metal frame;
wherein both the first radiating element and the first metal frame are electrically connected to the system ground, and the first circuit boards of the plurality of antenna units are integrated with each other.

13. The antenna module as claimed in claim 12, wherein the first radiating elements of the plurality of antenna units are arranged in an N*N plane array;
in any row and any column of the N*N plane array, any two adjacent first slots have unequal lengths, and two first slots adjacent to any first radiating element have equal lengths.

14. The antenna module as claimed in claim 13, wherein the feeding posts of (N-2)*(N-2) first radiating elements in a center of the N*N plane array are electrically connected to an external power source to form an active region;
the feeding posts of the first radiating elements around the (N-2)*(N-2) first radiating elements in the center of the N*N plane array are electrically connected to a matching load to form a passive region.

15. The antenna module as claimed in claim 14, wherein the antenna module further comprises:
a second circuit board, disposed at one side of the first circuit board away from the first radiating element, and
a radio frequency front end, disposed at one side of the second circuit board away from the first circuit board; wherein the radio frequency front end comprises a phase shifter configured to shift a phase of the plurality of antenna units.

16. The antenna module as claimed in claim 15, wherein the phase shifter comprises a plurality of phase shifting chips, some of the first radiating element arrays are arranged in an array to form a radiating element group, and each radiating element group is electrically connected to a corresponding one of the phase shifting chips.

17. The antenna module as claimed in claim 12, wherein the first circuit board comprises a first grounding layer, a first grounding spacer, a second grounding layer, a second grounding spacer, and a third grounding layers subsequently stacked on one another;
the first grounding layer defines a first slot;
each of the first grounding spacer, the second grounding layer, the second grounding spacer, and the third grounding layer defines a first clearance region facing the first slot;
each of the first grounding spacer, the second grounding layer, and the second grounding spacer defines a second clearance region perpendicularly intersected and communicated with the corresponding first clearance region defined in the first grounding spacer, the second grounding layer, and the second grounding spacer;
the first circuit board further comprises:
a feeding line, received in the second clearance region defined in the second grounding layer; and
a feeding post, running through the first circuit board, electrically connected to the feeding line, and electrically isolated from the first grounding layer, the second grounding layer, and the third grounding layer;
wherein the first metal frame and the first radiating element are arranged above the first grounding layer, the pair of first radiating arms of the first radiating element are symmetrically arranged at two opposite sides in a width direction of the first slot;
one of the first radiating arms is arranged to cover the feeding post, the first radiating arm defines a relief groove at one end facing the feeding post, and the relief groove is configured to provide a clearance for the feeding post.

18. The antenna module as claimed in claim 17, wherein the first circuit board further comprises a third grounding spacer and a fourth grounding layer;
wherein the third grounding spacer is disposed at one side of the third grounding layer away from the second grounding spacer, and the fourth grounding layer is disposed at one side of the third grounding spacer away from the third grounding layer;
the third grounding spacer defines a third clearance region, and orthographic projections of the first clearance region and the second clearance region projected on the third grounding spacer are all disposed within the third clearance region; and
the third grounding layer, the third grounding spacer, the third clearance region, and the fourth grounding layer cooperatively define a rear chamber of the antenna unit.

19. The antenna module as claimed in claim 12, wherein each of the pair of first radiating arms comprises:
a first side wall,
a second side wall, disposed at one end of the first side wall adjacent to the first metal frame and substantially perpendicular to the first side wall;
a third side wall, disposed at the other end of the first side wall opposite to the second side wall and substantially perpendicular to the first side wall;
a fourth side wall, substantially parallel to the first side wall, wherein the first side wall and the fourth side wall are disposed at two opposite end of the second side wall; and
a fifth side wall, connected between the third side wall and the fourth side wall;
wherein a length of the third side wall in a direction substantially perpendicular to the first side wall is less than a length of the second side wall in the direction substantially perpendicular to the first side wall;
a length of the fourth side wall in a direction substantially perpendicular to the second side wall is less than a length of the first side wall in the direction substantially perpendicular to the second side wall.

20. An electronic device, comprising:
a housing; and
an antenna module, disposed on the housing and comprising a plurality of the antenna units distributed in an array, wherein each of the plurality of antenna units comprises:
a first circuit board, wherein a system ground and a feeding structure are formed on the first circuit board;
a first metal frame, stacked on the first circuit board; and
a first radiating element, stacked on the first circuit board, wherein the first metal frame is arranged around an outer periphery of the first radiating element, the first radiating element comprises a pair of first radiating arms opposite to and spaced apart from each other, and the pair of first radiating arms are attached to two opposite inner surfaces of the first metal frame;
wherein both the first radiating element and the first metal frame are electrically connected to the system ground, and the first circuit boards of the plurality of antenna units are integrated with each other.
